(19) United States
(12) Patent Application Publication
(10) Pub. No.: US 2025/0010895 A1
(43) Pub. Date: Jan. 9, 2025

(54) RUNNING GEAR FOR A RAIL VEHICLE, COMPRISING A MAGNETIC RAIL BRAKE AND A CENTERING DEVICE, MAGNETIC RAIL BRAKE AND CENTERING DEVICE

(71) Applicant: Faiveley Transport Bochum GmbH, Bochum (DE)

(72) Inventors: Sebastian MONTUA, Bochum (DE); Christopher NATHAUS, Bochum (DE); Lasse SCHULTE-FARWIG, Bochum (DE)

(21) Appl. No.: 18/578,307

(22) PCT Filed: Jun. 13, 2022
(86) PCT No.: PCT/EP2022/065986

§ 371 Date: Jan. 10, 2024

(30) Foreign Application Priority Data
Jul. 14, 2021 (DE) 20 2021 103 772.5

(51) Int. Cl. B61H 7/08

(52) U.S. Cl. CPC B61H 7/086

(57) ABSTRACT

A running gear for a rail vehicle includes a magnetic rail brake. A centering device is provided by which vibrations can be damped to a high degree, and which has a low-cost structure. The magnetic rail brake can have a lifting device, a track rod and a coil attached to the track rod. The coil and the track rod can be moved between a low position and a high position by means of the lifting device. A centering device includes a centering means arranged on the track rod and a centering means receptacle arranged on the running gear. The centering means engages the centering means receptacle in the high position. The centering device comprises a damping element. The damping element is arranged between the track rod and the centering means.

### CROSS-REFERENCE TO RELATED APPLICATIONS

This application is a national phase entry of International Patent Application No. PCT/EP2022/065986 (filed 13 Jun. 2022), which claims priority to German Patent Application No. 20 2021 103 772.5 (filed 14 Jul. 2021), the entire disclosures of which are incorporated herein by reference.

### BACKGROUND

### Technical Field

The present invention relates to a running gear for a rail vehicle comprising a magnetic rail brake with a lifting device, a track rod and a coil attached to the track rod, wherein the coil and the track rod can be moved between a low position and a high position by means of the lifting device, wherein a centering device is provided, wherein the centering device comprises a centering means arranged on the track rod and a centering means receptacle arranged on the running gear, wherein the centering means engages the centering means receptacle in the high position, wherein the centering device comprises a damping element.

Furthermore, the present invention relates to a magnetic rail brake for a running gear and a centering device for a magnetic rail brake.

### Discussion of Art

Rail vehicles can have a magnetic rail brake. The magnetic rail brake is usually attached to a running gear, in particular a bogie, of the rail vehicle and comprises a coil attached to a track rod and a lifting device. The lifting device is connected to the running gear or bogie on the one hand and to the track rod on the other hand. By means of the lifting device, the track rod together with the coil can be lowered to a low position or raised to a high position. In the low position, the coil of the magnetic rail brake is located directly above a rail traveled by the rail vehicle. When the coil is energized, the coil and a sliding shoe provided on the magnetic rail brake are attracted to the rail. The resulting friction between the sliding shoe and the rail dissipates the kinetic energy of the rail vehicle. In addition, an eddy current induction occurs in the rail, which generates a force counteracting the movement of the rail vehicle.

In the high position, the track rod, the coil and the sliding shoe of the magnetic rail brake must be securely locked in place to prevent vibrations and shocks. So-called centering devices are known in the prior art for this purpose, which usually comprise a centering cone attached to the track rod and a centering cone receptacle on the running gear. In the high position, the centering cone engages in the centering cone receptacle, thus securing the track rod and the coil arranged therein against horizontal movement. Damping elements are provided to reduce further vibrations of the magnetic rail brake relative to the running gear caused by acceleration forces. In the prior art, the damping elements are arranged on the inside of the centering cone receptacle. In the high position, the centering cone rests against the damping element arranged in the centering cone receptacle. Vibrations from the track rods or the magnetic rail brake are transmitted to the damping element via the centering cone and are absorbed.

The known centering devices for magnetic rail brakes of running gears for rail vehicles have a relatively complicated structure and are therefore expensive to manufacture and maintain.

### BRIEF DESCRIPTION

The object of the present invention is to provide a running gear for a rail vehicle comprising a magnetic rail brake, wherein a centering device is provided with which vibrations can be damped to a high degree and which has a low-cost structure.

To solve the problem underlying the invention, a running gear for a rail vehicle comprising a magnetic rail brake with a lifting device, a track rod and a coil attached to the track rod is proposed, wherein the coil and the track rod can be moved between a low position and a high position by means of the lifting device, wherein a centering device is provided, wherein the centering device comprises a centering means arranged on the track rod and a centering means receptacle arranged on the drive, wherein the centering means engages the centering means receptacle in the high position, wherein the centering device comprises a damping element, wherein it is further provided that the damping element is arranged between the track rod and the centering means.

In contrast to centering devices for magnetic rail brakes of running gears for rail vehicles known from prior art, the damping element is thus not arranged on the centering means receptacle arranged on the running gear, but is located on the track rod, and there in particular between the track rod and the centering means. This results in a more cost-effective design.

The magnetic rail brake further preferably has a sliding shoe. The running gear may be or comprise a bogie.

The lifting device of the magnetic rail brake is attached at a first end to the running gear, in particular to the bogie, of the rail vehicle and at a second end to the track rod. By extending and retracting the lifting device, the track rod together with the coil and sliding shoe can be lowered to a low position or raised to a high position. In the high position, the centering means engages in the centering means receptacle from below. The centering means receptacle can also be referred to as a flange and can, in particular, be formed in the form of a flanged disc inserted into the running gear or the bogie.

Preferably, the centering means is a centering cone or a truncated cone.

In the context of the present invention, a centering cone is understood to be a body which has a cone-like outer surface. The centering means can also be a truncated cone.

Preferably it is provided that the damping element has a polymer, preferably a terpolymer, more preferably an ethylene-propylene-diene rubber, or is made of a polymer, preferably a terpolymer, more preferably an ethylene-propylene-diene rubber.

Such polymers are inexpensive and have a high damping capacity. They are therefore particularly suitable for providing a low-cost centering device that dampens vibrations to a high degree.

The damping element is preferably configured as a disc-shaped or plate-shaped blank. In particular, the damping element can be circular or annular in plan view.

With further advantage, it can be provided that no damping element is arranged between the centering means and the centering means receptacle.

Compared to the prior art, it is therefore preferable not to have a damping element arranged or attached to the centering means receptacle. In other words, the centering means in the high position directly abuts against the centering means receptacle without a damping element being located between the centering means and the centering means receptacle.

Furthermore, it is preferably provided that the centering means receptacle has a contact surface complementary to an outer surface of the centering means, in particular to a lateral surface of the centering cone or truncated cone.

In the high position, the centering means preferably engages in the centering means receptacle from below. If the centering means is a centering cone or a truncated cone, the centering cone or truncated cone has a lateral surface with a flank angle. The centering means receptacle, in particular the flange or flange disc, then has a contact surface on the underside which is complementary to the lateral surface and has the same flank angle.

Further preferably, it can be provided that the centering means consists of a polymer.

Experiments by the applicant have shown that a centering means consisting of a polymer can be manufactured inexpensively and offers a locking security equivalent to a centering means made of metal. In addition, a centering means consisting of a polymer can itself act as a damping element.

Further preferably, it can be provided that the centering means has a hole and that the damping element has an opening aligned with the hole, wherein the centering means is fastened to the track rod, in particular screwed to the track rod, by means of a fastening means, in particular a screw, guided through the hole and the opening.

The hole is preferably arranged centrally in the centering means and penetrates it continuously from top to bottom. The hole may also be referred to as a bore, aperture or duct. The hole is further preferably approximately formed circular or round. The damping element has an opening. If the damping element is formed substantially as a disc, for example of an ethylene-propylene-diene rubber, the opening of the damping element is preferably formed centrally in the damping element. The damping element, which is arranged between the track rod and the centering means, is arranged in particular on an underside of the centering means and on an upper side of the track rod. Through the opening aligned with the hole of the centering means, a fastening means can preferably be guided from an upper side through the centering means and the damping element and fastened to the track rod arranged below the damping element. If the fastening means is configured as a screw, the screw is screwed to the track rod. By this, the centering means and the damping element arranged between the centering means and the track rod are screwed to the track rod.

Preferably, the fastening means is a screw, in particular an M16 screw.

With further advantage, it can be provided that the centering means has a receptacle, wherein a head of the fastening means, in particular a head of the screw, is arranged in the receptacle.

The receptacle, which can also be referred to as a recess or depression, is arranged in particular in the upper side of the centering means, which is preferably configured as a truncated cone. The fastening means, in particular the screw, is guided from above through the hole in the centering means and the opening in the damping element below and fastened to the track rod below. The head of the fastening means, in particular the screw, is then recessed within the recess of the centering means.

It may be provided that a washer is arranged in the receptacle below the head of the fastening means.

A pre-tensioning force of the fastening means is transmitted to the centering means and the damping element via the washer.

Further preferably, it may be provided that the centering device comprises a sleeve, wherein the sleeve is arranged in the hole of the centering means, wherein further preferably the sleeve is arranged in the opening of the damping element.

In other words, the sleeve is arranged in the hole of the centering means and can also be arranged with a lower section in the opening of the damping element.

One function of the sleeve can be the transmission of the screw pre-tensioning force, wherein the screw pre-tensioning force is transmitted completely to the sleeve or is partially divided between the sleeve and the centering means with damping element.

Furthermore, it can be provided that an axial extension of the sleeve is equal to or smaller than the sum of the axial extensions of the hole of the centering means and the opening of the damping element.

It can preferably be provided that the sleeve is arranged with a radial clearance in the hole of the centering means.

Due to the radial clearance, a tolerance compensation can be compensated during assembly.

Advantageously, the radial clearance is between 1 mm and 5 mm, preferably approx. 3 mm.

Further preferably, the sleeve is arranged without a radial clearance in the opening of the damping element.

Preferably it is provided that the centering means has a diameter of from 80 mm to 100 mm, preferably about 90 mm, at a base.

Further preferably, it can be provided that the centering means has a height of from 20 mm to 40 mm, preferably from 26 mm to 34 mm.

Preferably, it can be provided that the damping element has a diameter of from 90 mm to 110 mm, preferably 95 mm to 96 mm.

With still further advantage, it may be provided that the damping element has a height of from 1 mm to 5 mm, preferably from 2 mm to 4 mm.

Preferably, it may be provided that the fastening means, in particular the screw, exerts a static pre-tensioning force of less than 75 kN, preferably less than 70 kN, more preferably less than 65 kN, on the centering means.

A further solution to the problem underlying the invention is a magnetic rail brake for a running gear as described above.

All functions, features and embodiments explained in connection with the running gear can also be transferred to the magnetic rail brake in a corresponding manner.

A still further solution to the object underlying the invention is to provide a centering device for a magnetic rail brake.

All functions, features and embodiments explained in connection with the running gear can also be transferred to the centering device in a corresponding manner.

A still further solution to the object according to the invention consists in providing a centering means for a centering device.

All advantages, features, embodiments and functions explained in connection with the running gear can be transferred to the centering means in a corresponding manner.

### BRIEF DESCRIPTION OF THE DRAWINGS

The invention is explained in more detail below with reference to the accompanying figures.

FIG. 1 shows a part of a running gear for a rail vehicle,

FIG. 2a shows a cross-sectional view of a centering device known from the prior art,

FIG. 2b shows an exploded view of the centering device known from the prior art,

FIG. 3a shows a cross-sectional view of a centering device according to the invention,

FIG. 3b shows an exploded view of the centering device according to the invention.

### DETAILED DESCRIPTION

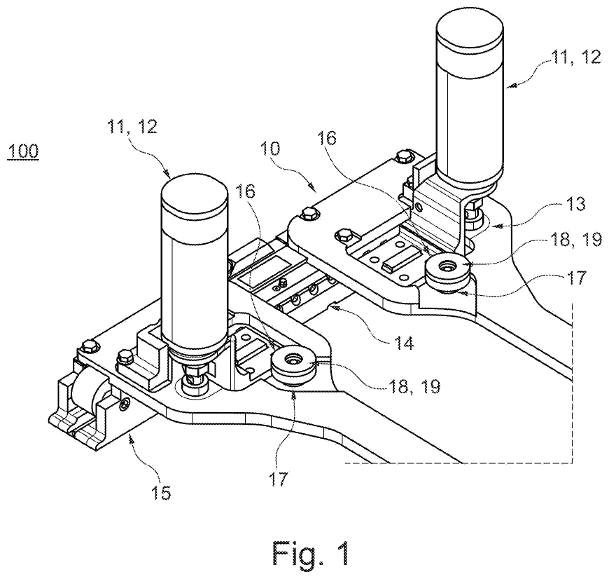

FIG. 1 shows a magnetic rail brake 10 of a running gear 100 for a rail vehicle not shown in more detail. The magnetic rail brake 10 comprises a lifting device 11, wherein the lifting device 11 is implemented by two pneumatic cylinders 12. The magnetic rail brake 10 further has a track rod 13. A coil 14 and at least one sliding shoe 15 are attached to the track rod 13. In the position shown, the pneumatic cylinders 12 of the lifting device 11 are retracted, so that the track rod 13 of the magnetic rail brake 10 is arranged in a high position. The running gear 100 or the magnetic rail brake 10, respectively, further has a centering device 16. The centering device 16 comprises centering means 17, which are attached to the track rod 13. Furthermore, the centering device 16 has centering means receptacles 18, which are formed as flange disks 19. The centering means receptacles 18 are attached to carriers of the running gear 100, which are not shown in more detail for reasons of clarity.

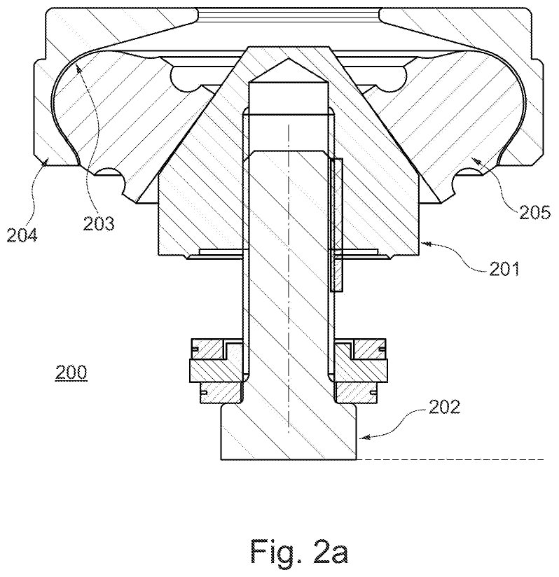

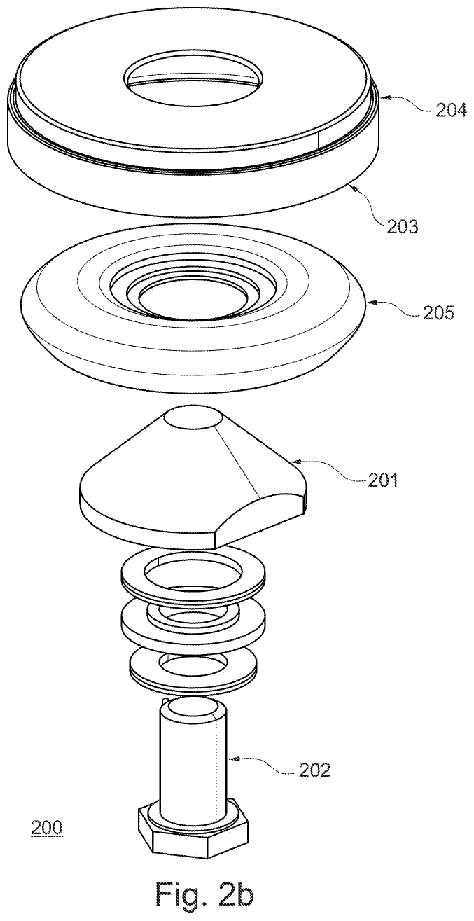

FIGS. 2a and 2b show a centering device 200 known from the prior art in a cross-sectional view (FIG. 2a) and in an exploded view (FIG. 2b). The known centering device 200 comprises a centering cone 201, which is connected to the track rod by means of a screw 202 guided from below through a track rod not shown. A roughly toroidal damping element 205 is arranged on an underside 203 of a centering flange 204. In the high position shown, the centering cone 201 moves into the centering flange 204 from below and abuts flush against the damping element 205, as shown in FIG. 2a.

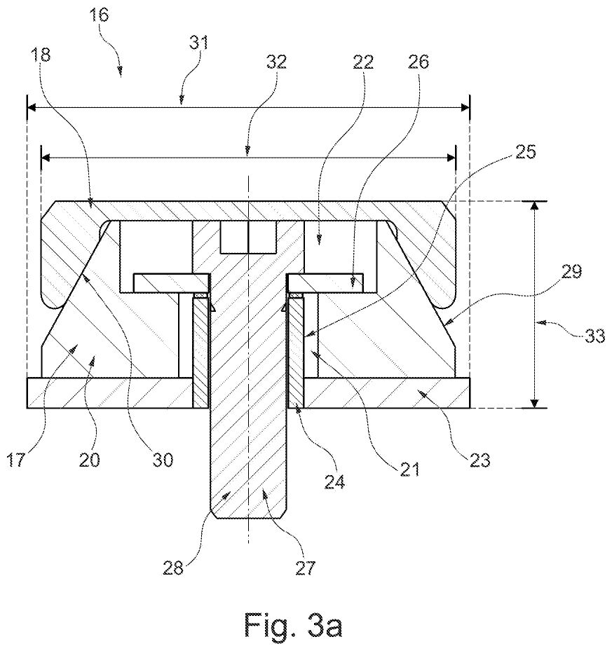

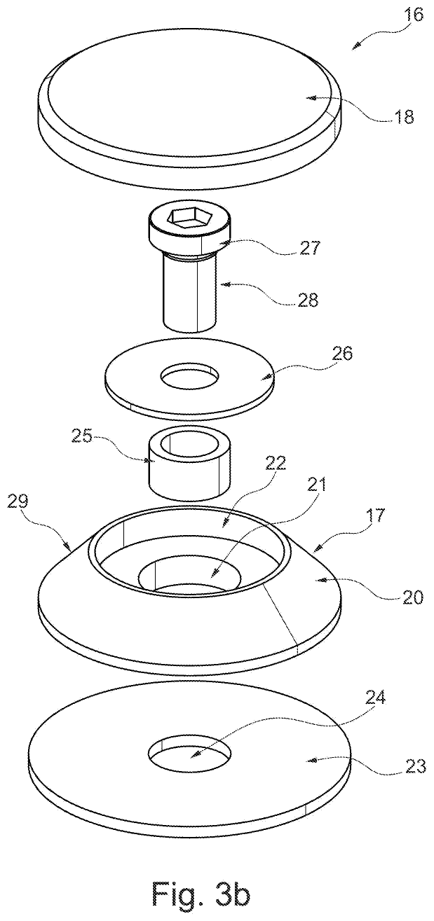

FIGS. 3a and 3b show a centering device 16 in accordance with the present invention. The centering device 16 has a centering means 17 which is formed as a truncated cone 20. The centering means 17 is made of a polymer. The centering means 17 or the truncated cone 20, respectively, has a central hole 21 and a receptacle 22 in the region of the upper side. A disc-shaped damping element 23 is arranged below the centering means 17. The damping element 23 is made of an ethylene-propylene-diene rubber. As shown in the cross-sectional view of FIG. 2a, a sleeve 25 is guided through the hole 21 of the centering means 17 and through a central opening 24 in the damping element 23, which sleeve is arranged in the hole 21 of the centering means 17 with a radial clearance. The sleeve 25 lies flush in the opening 24 of the damping element 23. Above the sleeve 25, a washer 26 is arranged in the receptacle 22. By means of a fastening means 28 configured as a screw 27, which is guided from above through the sleeve 25, the centering means 17 is screwed to the track rod 13 according to FIG. 1. The centering means receptacle 18 is fastened to a support of the running gear 100. The centering means 17 formed as a truncated cone 20 has a lateral surface 29 which, in the high position of the magnetic rail brake 10, abuts against an inner contact surface 30 of the centering means receptacle 18 which is complementary to the lateral surface 29. The diameter 31 of the damping element 23 is approximately 96 mm. The diameter 32 of the centering means receptacle 18 as well as of the centering means 17 is approximately 90 mm. The entire assembly of centering means receptacle 18, centering means 17 and damping element 23 has a height 33 of approximately 34 mm.

### LIST OF REFERENCE SIGNS

100 Running gear
10 Magnetic rail brake
11 Lifting device
12 Pneumatic cylinder
13 Track rod
14 Coil
15 Sliding shoe
16 Centering device
17 Centering means
18 Centering means receptacles
19 Flange disks
20 Truncated cone
21 Hole
22 Receptacle
23 Damping element
24 Opening
25 Sleeve
26 Washer
27 Screw
28 Fastening means
29 Lateral surface
30 Contact surface
31 Diameter
32 Diameter
33 Height
200 Centering device
201 Centering cone
202 Screw
203 Underside
204 Centering flange
205 Damping element

1. A running gear for a rail vehicle comprising:
a magnetic rail brake with a lifting device;
a track rod; and
a coil attached to the track rod, wherein the coil and the track rod can be moved between a low position and a high position by the lifting device; and
a centering device comprising a centering means arranged on the track rod and a centering means receptacle arranged on the running gear, wherein the centering means engages in the centering means receptacle in the high position, wherein the centering device comprises a damping element, wherein the damping element is arranged between the track rod and the centering means.

2. The running gear according to claim 1, wherein the centering means is a centering cone or a truncated cone.

3. The running gear according to claim 1, wherein the damping element has a polymer or consists of a polymer.

4. The running gear according to claim 1, wherein the damping element is a disk-shaped or plate-shaped blank.

5. The running gear according to claim 1, wherein no damping element is arranged between the centering means and the centering means receptacle.

6. The running gear according to claim 1, wherein the centering means receptacle has a contact surface complementary to an outer surface of the centering means, in particular to a lateral surface of the centering cone or truncated cone.

7. The running gear according to claim 1, wherein the centering means includes a polymer.

8. The running gear according to claim 1, wherein the centering means has a hole and wherein the damping element has an opening arranged in alignment with the hole, wherein the centering means is screwed to the track rod, by means of a screw, guided through the hole and the opening.

9. (canceled)

10. The running gear according to claim 8, wherein the centering means has a receptacle, wherein a head of the screw, is arranged in the receptacle.

11. The running gear according to claim 10, wherein a washer is arranged in the receptacle below the head of the screw.

12. The running gear according to claim 8, wherein the centering device comprises a sleeve, wherein the sleeve is arranged in the hole of the centering means, wherein the sleeve is arranged in the opening of the damping element.

13. The running gear according to claim 12, wherein the sleeve is arranged with a radial clearance in the hole of the centering means.

14. The running gear according to claim 13, wherein the radial clearance is between 1 mm and 5 mm.

15. The running gear according to claim 12, wherein an axial extension of the sleeve is equal to or smaller than a sum of the axial extensions of the hole of the centering means and the opening of the damping element.

16-19. (canceled)

20. The running gear according to claim 8, wherein the screw exerts a static pre-tensioning force of less than 75 kN on the centering means.

21. A magnetic rail brake for a running gear according to claim 1.

22. A centering device for a magnetic rail brake according to claim 21.

23. (canceled)

24. A Running gear according to claim 1, wherein the centering means has a diameter at a base of from 80 mm to 100 mm, or wherein the centering means has a height of from 20 mm to 40 mm, or wherein the damping element has a diameter of from 90 mm to 110 mm, or wherein the damping element has a height of from 1 mm to 5 mm.

25. A running gear according to claim 2, wherein the centering means receptacle has a contact surface complementary to a lateral surface of the centering cone or truncated cone.

26. A running gear according to claim 20, wherein the screw exerts a static pre-tensioning force of less than 65 kN on the centering means.
